(19) United States
(12) Patent Application Publication
(10) Pub. No.: US 2020/0262272 A1
(43) Pub. Date: Aug. 20, 2020

(54) FRAMELESS WINDSHIELD AND METHOD OF INSTALLATION

(71) Applicant: Craig Herndon, Palmetto, FL (US)

(72) Inventor: Craig Herndon, Palmetto, FL (US)

(21) Appl. No.: 16/792,176

(22) Filed: Feb. 14, 2020

Related U.S. Application Data
(60) Provisional application No. 62/805,957, filed on Feb. 14, 2019.

(51) Int. Cl. B60J 1/00

(52) U.S. Cl. CPC B60J 1/006

(57) ABSTRACT

The present invention provides for a frameless windshield which can encompass a particular area of a motor vehicle or watercraft and which does not include frame to an obstruct an operator's view. Certain aspects further include a frameless windshield which can withstand strong winds, rain or water without deformation to the point of destruction. Further aspects of the present invention provide for a method of fastening the same to a motor vehicle or water craft. The inventive windshield and method allows for the vision of an operator of a motor vehicle to remain unobstructed by water, rain, wind, or debris while operating the motor vehicle or water craft, and further avoiding blind spots by the elimination for the need of windshield frames.

### CROSS-REFERENCE TO RELATED APPLICATIONS

The present application claims priority of U.S. Provisional patent application No. 62/805,957 filed Feb. 14, 2019, the contents of which are herein incorporated by reference.

### FIELD OF THE INVENTION

The present invention relates to a windshield construction for motor vehicles, and more particularly to frameless windshields, and methods of constructing same.

### BACKGROUND OF THE INVENTION

Windshields for motor vehicles, and more particularly boats, are typically square, round or oval in shape for at least one purpose of providing a splash guard encompassing a console or a piloting area. This is to assist that the pilot, driver, or captain of the motor vehicle's vision is not obstructed by water, rain, wind, or debris while operating the motor vehicle or water craft.

Typical solutions include aluminum frames which bind a plurality of pieces of glass in order to encompass the desired area. While effective at preventing obstruction of an operator's vision from water, rain, wind, or debris while operating the motor vehicle or water craft, these frames often impair an operators view, and peripheral vision. Thus there remains an unmet need for a frameless windshield which can encompass a particular area of a motor vehicle or watercraft, which does not include frame. Moreover, there exists a need for a frameless windshield which can withstand strong winds, rain or water without deformation to the point of destruction. There further remains a an unmet need for a method of fastening the same to a motor vehicle or water craft.

### SUMMARY OF THE INVENTION

The present invention provides for a frameless windshield which can encompass a particular area of a motor vehicle or watercraft and which does not include frame to an obstruct an operator's view.

Certain aspects further include a frameless windshield which can withstand strong winds, rain or water without deformation to the point of destruction.

Further aspects of the present invention provide for a method of fastening the same to a motor vehicle or water craft.

### DESCRIPTION OF DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (Figs.) are listed below.

FIG. 1 illustrates a 100 frameless windshield which is mounted to a 101 lower landing and to a 102 upper landing.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

### DETAILED DESCRIPTION OF THE INVENTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

Various terms used throughout the specification and claims are defined as set forth below as it may be helpful to an understanding of the invention.

As used herein a “landing” means one or more surfaces for adhering one or more windshield. Where used individually, or together, and upper landing or lower landing refer the surfaces relative to the windshield.

As used herein a “windshield” means one or more screens, typically clear, but not required, attached to the body of a vehicle or motor craft in front of one or more operators to protect the operators from wind, rain, water and debris.

The present invention contains the features of and methods for construction for a frameless windshield to be used on a motor vehicle, including, without limit, cars, trucks and/or boats.

### Frameless Windshield

A 100 frameless windshield is provided which includes one or more windshield structures which is mounted to a 101 lower landing and to a 102 upper landing. The frameless windshield is mounted using one or more adhesives. It is intended that the frameless windshield does not use any mechanical fasteners, and is solely fastened to wither, or both, the upper or lower landing using the adhesives. Several suitable adhesives are known in the art, however non-limiting examples of suitable adhesives include, without limit, caulk, epoxy, marine polymer sealant, or combinations thereof.

The windshield may be made from suitable materials known in the art, including, without limit, glass, laminated glass, plexiglass, plastics, polymers, ceramics, or combinations thereof. In at least one embodiment, the windshield is shaped from a single pence of windshield material in a square-like, or circular-like, shape to provide one or more side pieces which encompass a particular area, thus providing an operator greater than a ninety (90) degree protection from wind, rain, water, and other debris. It should be appreciate that the windshield may be tempered to resist cracking or breaking, and may include one or more films or other material to provide for ultraviolet (UV) protection, anti-shattering protection, anti-fog protection, anti-glare protection, light polarization, or combinations thereof. Other films and materials known in the art may be used to provide other benefits. It should be further appreciated that the windshield should be formed to minimize or eliminate distortion, thus providing an operator a complete and unobstructed, and undistorted view and peripheral view.

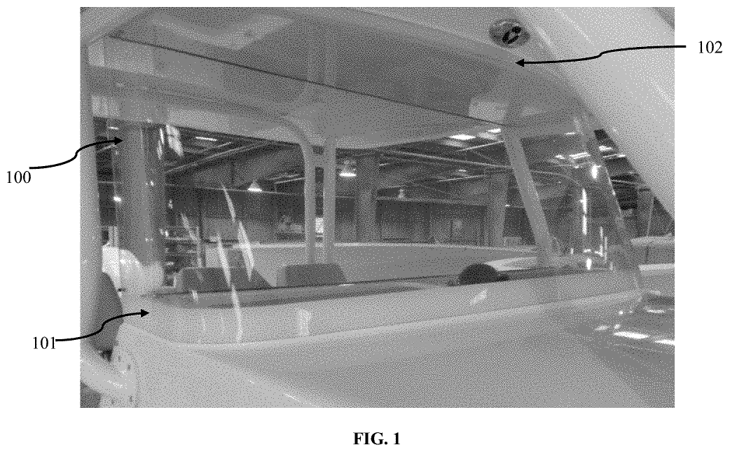

In at least one embodiment, the windshield is fastened by adhesive only to an upper landing. In another embodiment, the frameless windshield is fastened by adhesive only to a lower landing. While yet, in another embodiment, the frameless windshield is fastened by adhesive to both an upper landing and a lower landing. FIG. 1 provides that the 100 frameless windshield is provided which includes one or more windshield structures which is mounted to a 101 lower landing and to a 102 upper landing. It should be appreciated that additional landings may be used based on the particular use, the degree of bend of the windshield, or the overall size of the windshield. It should be appreciated that no mechanical fasters, mullions, or other support structures are required for the installation of the frameless window, using the inventive methods taught herein.

### Installation Method

Methods for installing the frameless windshield are unique. In at least one embodiment, a frameless windshield is provided. For its installation, spacers are fist placed along one or more landings of the windshield, on one or both of the horizontal and vertical surfaces of the landing. The windshield is then placed in the desired locations, and atop and/or against the shims. An adhesive is then applied in the void created between the windshield and the landing, and further between the shims, thus adhering the windshield to the one or more landings.

In at least one embodiment, after the adhesive has been applied, sufficient time is provided to allow for the adhesive to cure, and the shims are then subsequently removed. In such embodiments, additional adhesive is again applied to backfill the areas where the shims have been removed. It should be appreciated that the same or different adhesive may be used for the backfill adhesive.

In at least one embodiment, after or concurrently with the application of the backfill adhesive, a line of one or more adhesives is applied at the one or more junctions of the windshield and landings to provide a uniform adhesive line.

The spacers used may be of various sizes based on the size of the windshield. Furthermore, the spacing between the spacers may vary based on the size and weight of the windshield, or on the shape of the landing area.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A method for the installation of a windshield without using any frames or mechanical fasteners, the method comprising:
obtaining one or more windshield structures, wherein said windshield structure is a glass, laminated glass, plexiglass, plastics, polymers, ceramics, or combinations thereof.
placing one or more spaces along one or more vertical or horizontal landings where the windshield is desired to be placed;
setting the windshield in the desired placement location atop or against said shims; and
applying one or more adhesive in the void created between the windshield and landing area, and between, but not on, said shims.

2. The method of claim 1 further comprising:
allowing for sufficient time to allow said adhesive to cure;
removing said one or more shims; and
applying adhesive to backfill one or more voids created by the removal of the shims.

3. The method of claim 2 further comprising applying a line of one or more adhesive at one or more junctions created by the windshield and one or more landings to provide a uniform adhesive line.

4. The method of claim 1 wherein said adhesive is caulk, epoxy, marine polymer sealant, or combinations thereof.
